(19) United States
(12) Patent Application Publication
(10) Pub. No.: US 2007/0170256 A1
(43) Pub. Date: Jul. 26, 2007

(54) Reset circuit, data carrier and communication device

(75) Inventor: Klemens Breitfuss, Voitsberg (AT)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V., Eindhoven (NL)

(21) Appl. No.: 10/590,619

(22) PCT Filed: Feb. 24, 2005
(86) PCT No.: PCT/IB05/50675

§ 371 Date: Aug. 24, 2006

(30) Foreign Application Priority Data
Feb. 27, 2004 (EP) 04100784.0

(51) Int. Cl. G06K 7/08

(52) U.S. Cl. 235/451; 340/10.1; 235/449

(57) ABSTRACT

In a reset circuit (1) comprising a clock signal input (RC) for receiving a clock singal CL MD signal (CL) consisting of a sequence of clock signal cycles, and comprising a data signal input (RD) for receiving digital data signals (MD), which are encoded in such a manner that at least one signal edge (0→1, 1→ 0) appears per data bit in the data signal, are provided a counter (2) being connected to the data signal input (RD) and the clock signal input (RC) and being designed for counting the number (X) of clock signal cycles, which appear between a defined number of data signal edges, and comparing means (3), which comparing means (3) being designed for comparing the number (X) of clock signal cycles counted by the counter (2) with a lower limit (MIN) and/or with an upper limit (MAX) and which comparing means (3) being designed to produce a reset signal (RS), if the number (X) either remains below the lower object (MIN) or exceeds the upper limit (MAX), depending on the limit value (MIN, MAX) taken for comparison.

### FIELD OF THE INVENTION

The invention relates to a reset circuit comprising a clock signal input for receiving a clock signal consisting of a sequence of clock signal cycles, comprising a data signal input for receiving digital data signals, which digital data signals being encoded in such a manner that at least one signal edge appears per data bit in the data signal.

The invention further relates to a data carrier, comprising a logic circuit, which logic circuit being designed for receiving digital data signals and for producing output data and for receiving a reset signal, said reset signal (RS) being provided to set the logic circuit into a defined logical state.

The invention further relates to a communication device comprising a data carrier. The invention further relates to a communication device being designed for communication with a data carrier.

The invention also relates to a reset method for resetting a data carrier and a logic circuit, respectively, in a defined logic state.

### BACKGROUND OF THE INVENTION

A device for executing payment transactions is known from the document WO 2003/044710 A1, which device is designed as a mobile device, which has telecommunication means for communicating according to a mobile phone standard. The telecommunication means comprise what is known as a subscriber's identification module (SIM) card, which can receive account information of the user of the device from a smart card of the user, so that a monetary amount can be booked from the smart card for carrying out a payment transaction, wherein the mobile device can use the telecommunication means to communicate with a terminal to process the payment transaction by means of this terminal. The smart card can communicate wirelessly with reader stations by the known method.

The known mobile device, however, suffers from a disadvantage that, under certain circumstances in case of a break in the wireless communication between the smart card and the reader station, the operation of the smart card is not terminated properly, but persists in a state which is also called “hang”, in which state it is possible to carry out fraudulent manipulations on the smart card. While the breaking off of communication for a passive data carrier of a reader station, which carrier is supplied with electrical energy by means of electromagnetic signals, for example a carrier signal, generally remain without any result, because an energy storage (condenser) provided in the data carrier is emptied soon (within a range of milliseconds to seconds) and thus the time period for fraudulent manipulation till the complete switch-off of the data carrier is very short, the risk of manipulation remains on a data carrier that either has its own energy supply in the form of a battery or is installed in a communication device as a “virtual Smart Card” and is supplied with energy from the communication device, till either the battery of the data carrier is exhausted or the communication device is switched off.

### OBJECT AND SUMMARY OF THE INVENTION

It is an object of the invention to create a reset circuit of the type mentioned in the first paragraph, a data carrier of the type mentioned in the second paragraph, a communication device of the types mentioned in the third and fourth paragraph and a reset method of the type mentioned in the fifth paragraph, wherein the drawbacks indicated above are avoided.

To achieve the above-mentioned object, features according to the invention are provided on a reset circuit according to the invention, such that a reset circuit according to the invention can be characterized as follows:

Reset circuit comprising a clock signal input for receiving a clock signal consisting of a sequence of clock signal cycles, comprising a data signal input for receiving digital data signals, said digital data signals being encoded in such a manner that at least one signal edge appears per data bit in the data signal, comprising a counting stage being connected to the data signal input and the clock signal input and being designed for counting a number of clock signal cycles, which clock signal cycles appear between a defined number of data signal edges, and comprising comparing means, said comparing means being designed for comparing the number of clock signal cycles counted by the counting stage with a lower limit and/or with an upper limit and said comparing means being designed to emit a reset signal, if the number either remains below the lower limit or exceeds the upper limit, depending on the limit value taken for comparison.

To achieve the above-mentioned object, a reset circuit according to the invention being provided in such a data carrier.

To achieve the above-mentioned object, a data carrier according to the invention being provided with such a communication device and measures according to the invention being provided for communication with a data carrier according to the invention.

To achieve the above-mentioned object, features according to the invention have been provided with a reset method according to the invention such that a reset method according to the invention can be characterized as follows:

A reset method for resetting a data carrier and its logic circuit, respectively, in a defined logical state, comprising reception of a clock signal consisting of a sequence of clock signal cycles, and comprising reception of digital data signals, said digital data signals being encoded in such a manner that at least one signal edge appears per data bit in the data signal, and comprising counting of a number of clock signal cycles, which clock signal cycles appear between a defined number of data signal edges, and comprising comparison of the number of counted clock signal cycles with a lower limit and/or with an upper limit and comprising emitting of a reset signal for the logic circuit, if the number either remains below the lower limit or exceeds the upper limit, depending on the limit value taken for comparison.

The features according to the invention trigger a reset signal in the event of the wireless communication being broken off between a communication device (reader station) and a data carrier, which then sets the data carrier or its logic circuit to a defined logical state in which manipulations by outsiders on the data carrier are excluded. The reset circuit according to the invention is conceived here as a purely digital circuit, which can be integrated well in the contactlessly readable data carriers, because their space requirement and energy requirement are low. In particular, the reset circuit according to the invention does not need any clock generators of its own, which are comparatively costly and take up much space in, for example, those realized by using quartz, or work comparatively inaccurately in RC-or LC-oscillation circuits or require time-consuming trimming during manufacture and furthermore have high power consumption. A special advantage that has proved itself is that the reset circuit according to the invention, fulfills its function in the event that no clock signal is present though a data signal is, and also in the event that no data signal is present though a clock signal is.

According to the measures claimed in claim 3 the advantage derived is that the data carrier can work together with a communication device through a wired link and need not have its own coupling element and its own air interface, but the contactless data transfer can be affected via the communication device, which provides a coupling element and an air interface for the data carrier. This also makes it possible to construct systems with “virtual cards”.

According to the measures claimed in claim 4 the advantage derived is that the data carrier can work as a standalone device. The additional provision of a pad for wired data transfer does not affect the option of constructing a hybrid data carrier.

According to the measures as claimed in claim 5 the advantage derived is that the data carrier does not need any battery of its own. An optional energy storage means in the form of a coil or a condenser should be designed in such a manner that, in the event of failure of the electromagnetic field, the reset circuit can still continue to work long enough to generate a reset signal and thereby set the data carrier or its logic circuit reliably to a defined logical state.

According to the measures as claimed in claim 6 the advantage derived is that the data carrier can be used simultaneously for mobile phone applications and for applications relating to wireless data carriers, such as “smart cards” etc. This offers a large range of possible applications e.g. ticket ordering systems, electronic payment systems, secure electronic communication with authorities etc.

According to the measures as claimed in claim 8 the advantage derived is that the communication device forms a relay station for constructing a virtual smart card system.

According to the measures as claimed in claims 9 and 10 the advantage derived is that the reset circuit according to the invention remains functional even in those extreme cases where the electromagnetic field of a reader station, that means that the carrier signal is switched off completely and therefore neither clock signals nor data signals are present. At least one of these signals is simulated by the measures according to the invention.

According to the measures as claimed in claim 11 the advantage derived is that virtual smart card systems can be realized with standard devices.

These and other aspects of the invention are apparent from and will be elucidated, by way of non-limitative examples, with reference to the embodiment(s) described hereinafter.

### BRIEF DESCRIPTION OF THE DRAWINGS

The invention will be elucidated below by way of non-limitative Figures referring to the embodiments.

FIG. 1 shows a reset circuit according to the invention in the form of a block circuit diagram.

FIG. 2 shows a data carrier according to the invention in the form of a block circuit diagram.

FIG. 3 shows a communication device with a data carrier according to the invention in the form of a block circuit diagram.

### DESCRIPTION OF EMBODIMENTS

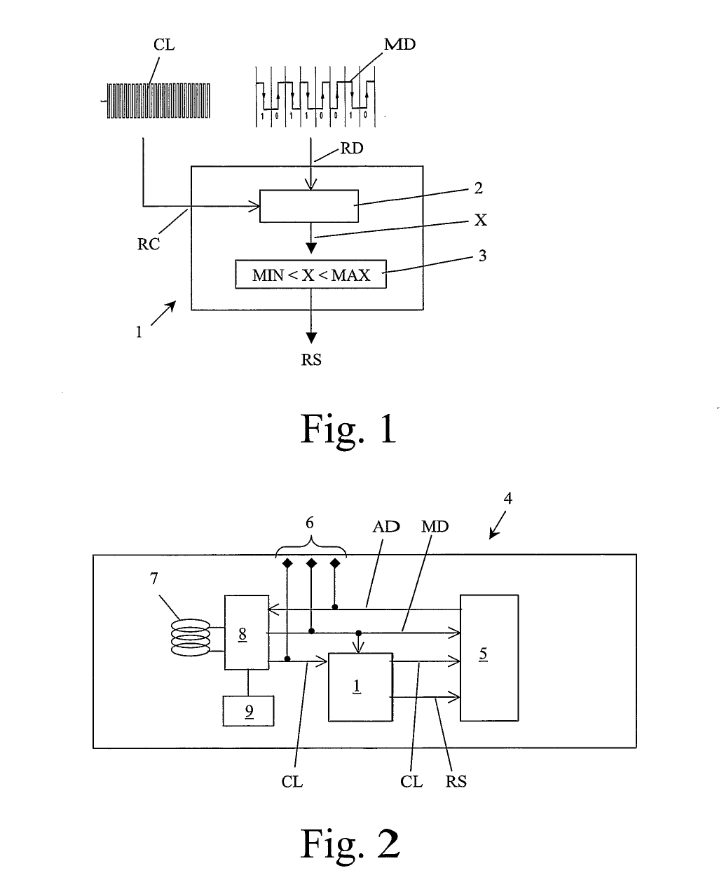

FIG. 1 shows a reset circuit 1 in form of a block circuit diagram. The reset circuit 1 comprises a clock pulse input RC, by which the reset circuit 1 receives a clock signal CL consisting of a sequence of clock signal cycles. Furthermore, the reset circuit 1 comprises a data signal input RD, by which it receives digital data signals MD. The digital data signals MD are encoded in such a way that they exhibit at least one signal edge (0→1, 1→0) per data bit. In the embodiment depicted, the data signal MD has Manchester coding, so each binary 1 is represented by a negative edge (1→0) in a half-bit period and each binary 0 by a positive edge (0→1) in a half-bit period. Furthermore, the reset circuit 1 comprises a counting stage, called counter 2 for short. Said counter 2 being connected with the data input RD and the clock input RC. The counter 2 is designed for counting a number X of clock pulse cycles, which appear between a defined number of data signal edges. In the simplest case, the counting period can lie between two neighboring data signal edges 0→1 or 1→0 as the case may be. Depending on the coding of the data signals MD the counting period can, however, also lie between two or more positive data signal edges or between two or more negative data signal edges. The counter 2 can be realized as a gate circuit, where the data signal edges represent the control signal for opening and closing the door, where the clock pulses are let through to digital counters if the gate is open. Signal shaping means such as a comparator can also be provided before the counters. It should be mentioned that the counter 2 is designed in such a manner that its count value is reset to zero at the beginning of each counting period.

The number X of the clock signal cycles counted by the counter is fed to comparing means 3, which compare the number X of clock signal cycles with a given lower limit MIN. The lower limit MIN is defined in such a way that a variation of the frequency of the clock signals within a tolerance does not yet lead to remaining under the lower limit within the particular counting period. If the clock signal, however, fails completely, then the predefined lower limit is recognized at the latest in the counting period after the current counting period and a reset signal RS is generated thereupon by the comparing means 3. The reset signal RS can have a defined logical level or a level transition or a certain level or signal pattern.

Other cases can also occur in practice. In one of these cases not the clock signal but the data signal fails. In order that the reset circuit 1 generates a reset signal RS even in such case, there is provided in an embodiment according to the invention that the comparing means comparing the number X of clock signals counted by counter 2 with an upper limit MAX and delivering the reset signal RS, if the upper limit MAX is exceeded.

Accordingly, the upper limit MAX limits a first value range at its bottom and the lower limit MIN a second value range at its top and the reset signal RS is generated, as soon as the number X of clock signal cycles leaves a third allowed value range, which lies between the lower limit MIN and the upper limit MAX, i.e. represents a value, which lies in the first value range or the second value range.

At this point it should be mentioned that not both limits MIN or MAX need be included in the comparison, but rather that even a realization can be imagined in which only the upper limit MAX or the lower limit MIN is taken for comparing with the counted number of clock signal cycles.

Should, however, the data signal as well as the clock signal fail, the reset circuit 1 would “freeze”. Suitable measures in connection with a communication device are described in greater detail below.

The reset circuit 1 according to the invention is suitable preferably for inclusion in a data carrier 4 designed for contactless communication as shown by means of the block circuit diagram in FIG. 2. The data carrier 4 illustrated in FIG. 2 comprises, besides the reset circuit 1, a logic circuit 5, which is designed for receiving digital data signals MD and for delivering output data AD as well as for receiving one of the reset signals RS produced by the reset circuit 1. The logic circuit 5 is immediately set by the reset signal RS to a defined logical state which is generally a Stop state, i.e. a state before the recording of a regular communication which was terminated or interrupted in an irregular manner by failure of the clock signal or data signal or both signals. This reliably prevents the logic circuit 5 from continuing in a logical state which would make possible reading of the data or the manipulation of the data carrier 4 or of the data stored in it by a card reader not shown in FIG. 2, in the event of failure of the clock signal or the data input signal MD. The data carrier 4 has a pad 6, from which three connections are shown for connecting external data input lines, data output lines, clock signal lines, by which the data signal MD and the clock signal CL can be supplied to the reset circuit 1 and to the logic circuit 5 by a wire connection and also data output signals DA generated by the logic circuit 5 can be transmitted. Power supply lines could also be connected to the data carrier through the pad 6 with additional connecting areas, which is, however, not shown explicitly in the present case.

In the present embodiment the data carrier 4 is built by the hybrid method. That means that it also comprises resources for wireless transmission of electromagnetic signals, namely a coupling element 7 arranged as an antenna for wireless sending/ receiving of electromagnetic signals and what is called an air interface 8, which is designed for processing received electromagnetic signals and for processing the data output signals DA to be transmitted. It should be mentioned at this point that the coupling element 7 can also be realized with the help of condenser plates or a transmission coil.

In detail, the air interface 8 is designed to extract from the received electromagnetic signals data signals MD, which are usually represented by an amplitude or phase modulation of a carrier signal and a clock signal CL and forward them to the reset circuit 1 or the logic circuit 5. The clock signal CL mostly corresponds to the carrier frequency of the electromagnetic high-frequency field i.e. of the carrier signal. The data signals MD are coded in the high-frequency field in the Manchester code as standard and thus fulfill the condition required for functioning of the reset circuit according to the invention, namely, that at least one signal edge appears in the data signal per data bit. Furthermore, the air interface 8 is designed for modulating the electrical high-frequency field (e.g. by load modulation), to send the data signals DA to the reader station.

The data carrier 4 can be designed, for example, as a passive data carrier according to the standard ISO/IEC 14443, i.e. not having its own energy supply, but supplied with the energy of the received electro-magnetic signals. For this purpose, the air interface 8 is designed for extracting of electrical energy from the carrier signal and for supplying the reset circuit 1 and the logic circuit 5 with energy, wherein the extracted electrical energy is temporarily stored in an energy storage means 9. Said energy storing means P being realized as condenser but can also be realized as coil.

It should be mentioned that the logic circuit can be designed as a Secure Application Module (SAM), which module ensures a relatively more secure run of a software application through encapsulation and encryption of the data to be processed.

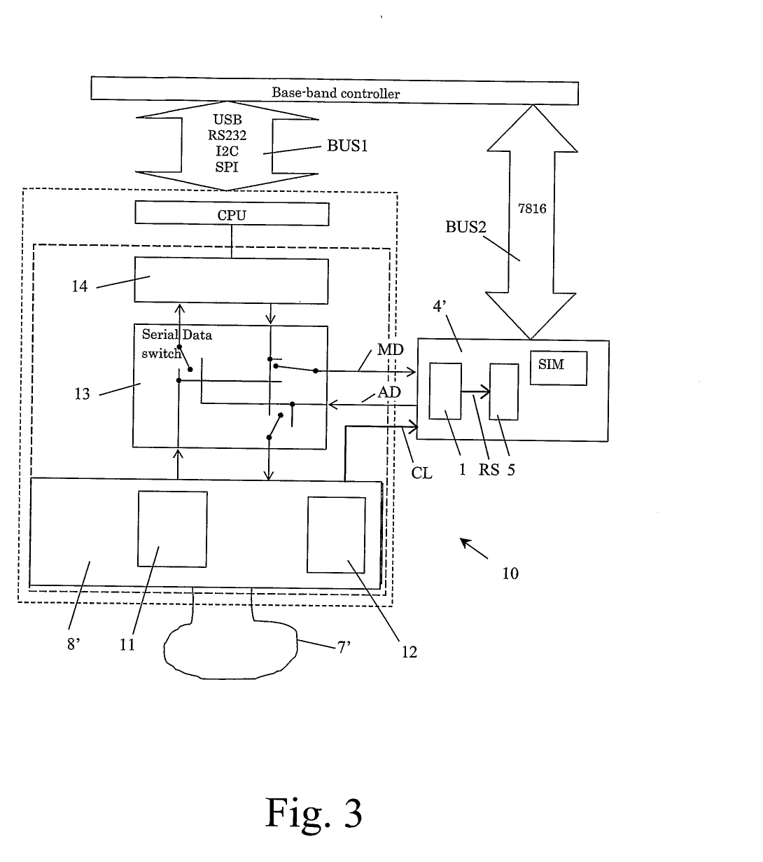

A communication device 10, containing a data carrier 4′, designed as a mobile telephone is depicted in FIG. 3 by means of a block circuit diagram. The data carrier 4′ is very similar to the data carrier 4 shown in FIG. 2 and described above. The data carrier 4′ comprises a reset circuit 1 according to the invention and a logic circuit 5. Regarding the functioning of these modules it is referred to the above description.

Furthermore, the data carrier 4′ comprises a subscriber's identification module (SIM) for mobile phone applications and can therefore be used simultaneously as a contactlessly readable data carrier and as a SIM card of a mobile phone, which offers new types of application options, such as, for example, commercial transactions, where it is especially advantageous in the present case that the data carrier 4′ can be transported from one device to another and has therefore a more flexible use.

The data carrier 4′ does not, however, contain any coupling element and any air interface, so it is not a contactlessly readable data carrier, but gets this function only due to the interaction with the communication device 10, which comprises the necessary components for realizing a wireless communication, also called contactless communication, with a reader station. The communication device 10 together with the data carrier 4′ forms a “avirtual non-contact data carrier” which is also referred to as “virtual smart card”, where the communication device 10 forms a data carrier relay device, which communicates with a reader station, not shown, as if it were a contactlessly readable data carrier, while the actual safety-relevant application data are on the data carrier 4′ and are forwarded to the reader station by means of the data carrier relay device.

As already mentioned, the communication device 10 is designed as a mobile phone. The central control element of the mobile phone is a baseband controller BBC. The mode of operation and function of a baseband controller BBC is well known to technically skilled persons in the field of mobile telecommunications and therefore needs no special explanation. It should, however, be mentioned that the baseband controller BBC communicates with the subscriber identification module (SIM) implemented on the data carrier 4′ over the data bus BUS2, which is designed for Smart Cards in conformance with the ISO 7816 standard, to read out and store user data etc. To address the logic circuit 5 on the data carrier 4′ and to communicate with a reader station for contactless data carriers, the communication device 10 additionally comprises means of communications explained in greater detail below. These means of communications comprise a coupling element 7′ for contactless information transmission between the communication device 10 and the reader station and an air interface 8 for processing the received electromagnetic signals and data to be sent. The air interface 8′ extracts digital data reception signals MD from the received electromagnetic signals and clock signals CL (pulses), to forward them to the data carrier 4′. Conversely, output data AD received by the data carrier 4′ are transmitted to a reader station using the air interface 8′ and the coupling element 7′. A serial data reversing switch 13 (serial data switch) serves to forward the data reception signals MD optionally to the data carrier 4′ or to the baseband controller BBC of the mobile phone via a transcoder 14, a CPU and a data bus BUS1. Similarly, the data switch 13 serves to optionally transmit output data AD coming from data carrier 4′ or output data generated by the baseband controller BBC and processed over the data bus BUS1, the CPU and the transcoder 14 to a reader station via the air interface 8′ and the coupling network 7′. Accordingly, the data carrier 4′ as well as the communication device 10 can communicate with a reader station by means of the serial data switch 13. It should be mentioned that the data bus BUS1 works according to the selected version, for example according to one of the standards USB, RS232, I²C or SPI. It should be mentioned that the communication device 10 can be configured advantageously, not only as a mobile phone, but also as a personal digital assistant (PDA) or a personal computer, which can in turn have interfaces to connect to data networks or telecommunications networks.

If the communication device is removed from the near field of a reader station, the field strength of the electromagnetic field generated by the reader station and received at the coupling element 7′ decreases, until it falls below a critical limit, at which no data and/ or no clock signal (clock pulse) can be extracted from the field anymore. Thus the communication between a reader station and the data carrier 4′ is lost at a point in time which is not exactly foreseeable. The logic circuit 5 of the data carrier 4′ is mostly realized as what is called as a state machine or by a micro-processor, on which software is executed. Operating states, in which the direct loss of communication without regular termination of the communication leads to the possibility that the data carrier 4′ can be manipulated, can occur in both the embodiments. Whereas this does not present a serious problem in passive data carriers, which are supplied with electrical energy by means of the electromagnetic field generated by the reader station, because the voltage supply of the data carrier collapses along with the vanishing electromagnetic field and, consequently, no data can be transmitted any more or the previously present operating state is lost, in case of virtual smart cards—as shown in the example in FIG. 3—the data carrier 4′ is supplied with electrical energy by the communication device 10, due to which the data carrier 4′ can remain hung in the unfavorable operating state described. In order to avoid such a disadvantageous operating state, the data carrier 4′ according to the invention is equipped with the reset circuit 1. The functioning of the reset circuit 1, however, requires that either the data signal or the clock signal continues at least provisionally, while the other signal is absent. As this cannot be guaranteed in practice, a further embodiment of an air interface 8′ is proposed for solving the problem, in that a pseudo data generator is provided 11 in an embodiment, which generator is designed for the purpose of rendering a pseudo data signal available for conveyance to the data carrier 4 which signal is coded such that for each data bit at least one signal edge occurs in the data signal, when no electromagnetic signals from which valid data signals could be extracted can be received, via the coupling element 7. The logic circuit 5 of the data carrier 4′ must be designed in this case such that it can differentiate the pseudo data from the real data. This is easy to realize by having such values assigned to the pseudo data or data combinations, which do not occur in real data signals according to agreement or a standard. In an alternative embodiment, the air interface 8′ comprises a pseudo clock signal generator 12, which is designed for the purpose of making available a pseudo clock signal consisting of a sequence of clock signal cycles for forwarding to the data carrier, if no electromagnetic signals can be received through the coupling element 7′, from which electromagnetic signals valid clock pulses can be extracted. It will be understood that the pseudo data generator 11 or the pseudo clock signal generator 12 are switched off as soon as the communication to a reader station can be resumed.

1. Reset circuit comprising a clock signal input for receiving a clock signal consisting of a sequence of clock signal cycles, comprising a data signal input for receiving digital data signals, said digital data signals being encoded in such a manner that at least one signal edge appears per data bit in the data signal, comprising a counting stage being connected to the data signal input and the clock signal input and being designed for counting a number of clock signal cycles, which clock signal cycles appear between a defined number of data signal edges, and comprising comparing means, said comparing means being designed for comparing the number of clock signal cycles counted by the counting stage with a lower limit and/or with an upper limit and said comparing means being designed to emit a reset signal, if the number either remains below the lower limit or exceeds the upper limit, depending on the limit value taken for comparison.

2. A data carrier comprising a logic circuit said logic circuit being designed for receiving digital data signals and for producing output data and for receiving a reset signal said reset signal being provided to set the logic circuit into a defined logical state, wherein the data carrier comprising a reset circuit as claimed in claim 1 and wherein the reset signal of the reset circuit being provided to be supplied to the logic circuit.

3. A data carrier as claimed in claim 2, wherein the data carrier comprising a pad for connecting external data input lines, data output lines, clock signal lines and preferably power supply lines to the reset circuit and the logic circuit respectively.

4. A data carrier as claimed in claim 2, wherein the data carrier comprising a coupling element for contactless transmission of signals and comprising an air interface for processing received signals, wherein the air interface being provided for extracting data signals and clock signals from the received signals and for forwarding the extracted data signals to the reset circuit and the logic circuit respectively.

5. A data carrier as claimed in claim 4, wherein the air interface being designed for extracting electrical energy for supplying the reset circuit and the logic circuit with energy, wherein the extracted electrical energy being preferably buffered intermediately in an energy storage means.

6. A data carrier as claimed in claim 2, wherein the data carrier comprising a subscriber's identification module for a mobile telephone application.

7. A communication device comprising a data carrier as claimed in claim 2.

8. A communication device being designed for communicating with a data carrier as claimed in claim 3, wherein the communication device comprising a coupling element for contactless transmission of signals and an air interface for processing received signals, wherein the air interface being provided for extracting digital data reception signals and clock signals from the received signals and for making the digital data reception signals available for forwarding to the data carrier.

9. A communication device as claimed in claim 8, wherein the air interface comprising a pseudo data generator said data generator being designed for making a pseudo data signal, which said pseudo data signal being coded in such a way that at least one signal edge occurs per data bit in the data signal, available for forwarding to the data carrier, if no signals can be received by the coupling element from which signals valid data reception signals could be extracted.

10. A communication device as claimed in claim 8, wherein the air interface comprising a pseudo clock signal generator said pseudo clock signal generator being designed for making available a pseudo clock signal consisting of a sequence of clock signal cycles for forwarding to the data carrier, if no electromagnetic signals can be received by the coupling element from which electromagnetic signals valid clock signals could be extracted.

11. A communication device as claimed in claim 7, wherein the communication device being designed as a mobile phone, a personal digital assistant or a personal computer.

12. A reset method for resetting a data carrier and its logic circuit respectively, in a defined logical state, comprising reception of a clock signal consisting of a sequence of clock signal cycles, and comprising reception of digital data signals, said digital data signals being encoded in such a manner that at least one signal edge appears per data bit in the data signal and comprising counting of a number of clock signal cycles, which clock signal cycles appear between a defined number of data signal edges, and comprising comparison of the number of counted clock signal cycles with a lower limit and/or with an upper limit and comprising emitting of a reset signal for the logic circuit if the number either remains below the lower limit or exceeds the upper limit depending on the limit value taken for comparison.
